(19) United States
(12) Patent Application Publication
(10) Pub. No.: US 2008/0160978 A1
(43) Pub. Date: Jul. 3, 2008

(54) Apparatus, Method, And Computer Program Product For Outputting Data

(75) Inventors: Petri Ju Tuominen, Tampere (FI); Mika Antikainen, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/618,279

(22) Filed: Dec. 29, 2006

(51) Int. Cl. H04M 1/247

(52) U.S. Cl. 455/418

(57) ABSTRACT

A mobile terminal, such as a mobile data device, is provided. The mobile terminal includes an audio device and a display device configured to output, perhaps selectively, respective audio and visual representations of data. The mobile terminal also includes an interface for detecting and generating an indication of an external event. A processor is configured to receive the indication of the external event and to cause the audio device to output at least some data in response to the indication of the external event. Such audio output may supplement, or in some cases replace, the visual output, as dictated by the processor and based on the indication of the external event. The extent of data outputted in audio and/or visual form may be selected by a user. A corresponding method and a computer program product are also provided.

### FIELD OF THE INVENTION

Embodiments of the present invention relate generally to an apparatus, a method, and a computer program product for outputting data, and, more particularly, to an apparatus, a method, and a computer program product for selectively outputting data in audio form in response to an external event.

### BACKGROUND INFORMATION

Many users of mobile communications/data devices tend to interact with these devices in parallel with other tasks. For example, it has become common to talk on a cellular telephone while driving. However, in some cases, such mobile devices can be a distraction from other activities. In response to this problem, many mobile devices have been constructed to interface with a headset or other device that allows the device to be utilized with limited manual manipulation. This decreases the extent to which the mobile device acts as a distraction from other activities. Further, in the case of a headset, a user may interact with audio data utilizing one sense, hearing, while dedicating another sense, vision, to the other tasks (such as driving, to again invoke a common example).

Despite this advance, mobile devices may still be a distraction in some cases. For example, mobile devices often include a display portion for outputting a visual representation of data. These same devices may incorporate the ability to receive an audio output of some types of data, but this capability is often limited to very specific, and often predetermined, types of data. For example, some conventional mobile devices include an electronic calendar feature that stores appointment times. These features often provide an audio output when an appointment time is approaching (e.g., an alarm bell 15 minutes before the appointment time). However, typically a user must still consult the visual display of the mobile device to obtain the details of the appointment, such as an associated location and/or subject. As such, the audio output provides only limited relief from visual distraction. Further, a user of a mobile device often has no ability to alter the manner in which data is outputted, despite the fact that a user may desire a visual output in some circumstances and an audio output in others. As such, an improved technique for outputting data is desirable.

### BRIEF SUMMARY OF THE INVENTION

In light of the foregoing background, exemplary embodiments of the present invention provide improved apparatuses, methods, and computer program products for selectively outputting data in audio form from a mobile terminal in response to an external event. By predicating such selective audio output on an external event, mobile terminal users may receive data outputs in a form that is convenient in light of the present situation of the user.

In one aspect, a mobile terminal, such as a mobile data device, is provided. The mobile terminal includes an audio device and a display device configured to output, perhaps selectively, respective audio and visual representations of data. The mobile terminal also includes an interface for detecting and generating an indication of an external event. The mobile terminal also includes a processor that is configured to receive the indication of the external event and to cause the audio device to output the at least some data in response to the indication of the external event. Such audio output may supplement, or in some cases replace, the visual output, as dictated by the processor and based on the indication of the external event. The outputted data may correspond to some or all of the data received by the processor and/or mobile terminal, and the extent of data outputted in audio and/or visual form may be selected by a user, for example, through user defined settings inputted, say, via a user input device. The mobile terminal may include a memory in communication with the processor and configured to store one or more settings to which the processor may respond.

In one embodiment data may include alarm data and data associated with the alarm data. In another embodiment, the audio device may include a coupling portion for coupling to a headset. The interface may be integrated with the coupling portion, with the interface providing the indication when a headset is coupled to the coupling portion.

According to another aspect of the present invention, a method for generating an output is provided. As part of the method, data are provided, and a visual representation of at least some of the data is outputted. An external event is detected, and an indication of the external event is provided. Based on the indication of the external event, an audio representation of the at least some of the data is outputted.

According to yet another aspect of the present invention, a computer program product is provided. The computer program product includes a computer-readable storage medium having computer-readable program code portions stored therein. The computer-readable program code portions include a first executable code portion for providing data. Also included is a second executable code portion for outputting a visual representation of at least some of the data. A third executable code portion allows detection of an external event, with an indication of the external event being provided via execution of a fourth executable code portion. A fifth executable code portion allows for outputting of an audio representation of at least some of the data based on the indication of the external event.

According to still another aspect of the present invention, an apparatus is provided. The apparatus includes means for outputting, perhaps selectively, an audio and a visual representation of at least some data. The apparatus also includes means for detecting and generating an indication of an external event. Means are further provided for receiving the indication of the external event and causing the audio output means to output the at least some data in response to the indication of the external event.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic perspective view of a mobile terminal configured in accordance with an exemplary embodiment;

FIG. 2 is a block diagram of the mobile terminal of FIG. 1, illustrating various operational units; and

FIG. 3 is a flow chart illustrating operations of a method according to an exemplary embodiment.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

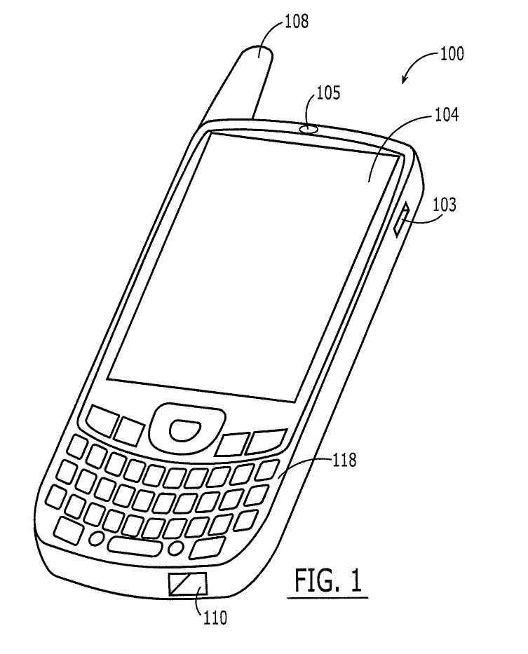

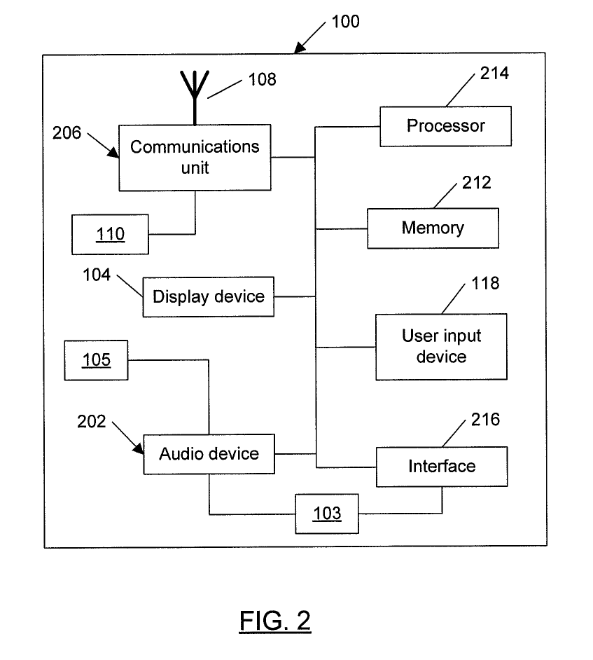

Referring to FIGS. 1 and 2, therein is shown a mobile terminal 100 configured in accordance with an exemplary embodiment. It should be understood, however, that a mobile data device as illustrated and hereinafter described is merely illustrative of one type of mobile terminal that would benefit from embodiments of the present invention and, therefore, should not be taken to limit the scope of embodiments of the present invention. While one embodiment of the mobile terminal 100 is illustrated and will be hereinafter described for purposes of example, other types of mobile terminals, such as portable digital assistants (PDAs), cellular telephones, pagers, mobile computers, mobile televisions, gaming devices, laptop computers, cameras, video recorders, global positioning system (GPS) devices, and other types of voice and text communications systems, can readily employ embodiments of the present invention. Furthermore, devices that are not mobile may also readily employ embodiments of the present invention.

The mobile terminal 100 may incorporate an audio device 202, which may include, for example, an audio speaker system 105 for outputting sound. Audio device 202 may also include a coupling portion, for example, a port 103 or a sensor for sensing an electromagnetic signal (e.g., a wireless connection), for coupling to a headset or other listening device. Mobile terminal 100 may also include a display device 104 such as, for example, a liquid crystal display (LCD). As such, mobile terminal 100 may include at least two output mechanisms, although more output mechanisms or devices may be included.

At times, mobile terminal 100 may receive, include, and/or otherwise access data. For example, mobile terminal 100 may include a communications unit 206, such as a receiver, transmitter, and/or transceiver, in communication with an antenna 108 for connecting to a wireless network and/or a port 110 for accepting a physical connection to a network, such that data may be received via one or both types of networks. Mobile terminal 100 may include a memory 212 that stores data, possibly after being received via antenna 108 or port 110. Regardless of the origin of the data, these data may be outputted to a user of mobile terminal 100 via audio device 202, display device 104, and/or any other output devices provided with mobile terminal 100.

Mobile terminal 100 may include a processor 214 capable of controlling the mode of output (e.g., audio, visual, etc.) of at least some of the data (i.e., a subset of the data) from mobile terminal 100. Processor 214 may be configured to cause a portion of such data, by default, to be outputted via display device 104 only, and to be outputted via audio device 202 in response to receiving an indication of an external event. The indication of the external event may be provided by an interface 216, which may be configured to detect the external event and to produce an indication thereof. When receiving the indication of the external event, processor 214 may cause the data to be outputted from audio device 202 instead of display device 104, or may cause the data to be outputted from both devices in parallel. As such, the output from either audio device 202 or display device 104 may be selective.

While some of the data received by/included in mobile terminal 100 may be treated as described above, other portions of data may, for example, be subject to default output via both audio device 202 and display device 104, and still other portions of data may be subject to default output via audio device 202 only. Also, in some embodiments, processor 214 may determine the output mode for only some types of data, with the output mode for other types being predetermined.

Any external event may be utilized for prompting an output via audio device 202, with the interface 216 chosen to be consistent with the target external event. For example, in some embodiments, the external event may be the depression of a button on mobile terminal 100 by a user; interface 216 would then include a depressible button, such as a button on the keypad of the mobile terminal, a dedicated button, or a soft key, and possibly associated circuitry that outputs an electrical signal to the processor when the button is physically actuated (e.g., depressing the button closes a switch and alerts the processor). In some embodiments, the external event may be an indication that an audio output is appropriate or desired. For example, interface 216 may be integrated with headset port 103. When a headset is inserted into port 103 (a possible indication that audio output is preferred), interface 216 would sense and send an indication of this coupling to processor 214 (e.g., inserting the headset causes a switch to close), which would cause data to be outputted via audio device 202 (and ultimately via port 103 and the associated headset). In some cases, processor 214 may be configured to control output in response to multiple external events, either acting in response to any of the multiple external events individually or in response to a simultaneous or near-simultaneous occurrence of the external events. For example, processor 214 may cause data to be outputted via audio device 202 when a headset has been inserted into port 103 and a button on mobile terminal is depressed.

As used above, “default” operation of a mobile terminal 100 refers to the operation of mobile terminal 100 in the absence of some intervening factor or force. However, in some cases, mobile terminal 100 may accept settings, either embedded in the hardware and/or software or continuously adjustable by a user, which dictate the mode of operation of mobile terminal 100 and the manner in which data are outputted. Each adjustment of such settings would indicate the “default” behavior of the mobile terminal 100 until such settings are once again adjusted, say, by entering values using a user input device 118 of mobile terminal 100. Possible user input devices include, but are not limited to, a mouse, a keyboard or keypad, a stylus, a trackball, and the like. Settings may be temporarily or permanently stored in memory 212. For example, a user may adjust the settings of a mobile terminal such that the processor directs only specific types of data (e.g., electronic mail, calendar information) to be outputted by audio device 202. Alternatively, a user may adjust the settings of a mobile terminal such that the processor directs data to be outputted by audio device 202 only in response to one or more specific external events. In one embodiment, a user may adjust the setting of mobile terminal 100 to provide an audio and visual output for any data associated with an alarm signal. This may increase the opportunity for a user to be made aware of such data which, due to its association with an alarm, may be of significant importance.

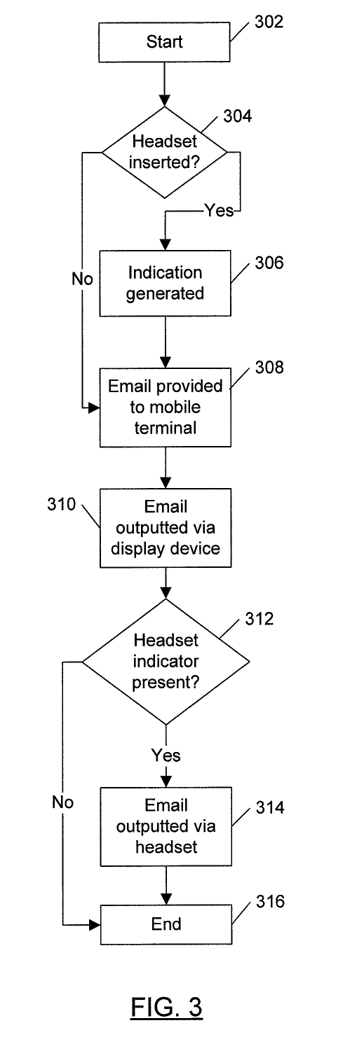

Referring to FIG. 3, an exemplary method for using the above described mobile terminal is now outlined. The method starts at Block 302, at which time a user of a mobile terminal may or may not insert a headset into a mating port on the mobile terminal. If a headset is so inserted, this is determined at Block 304, for example, by an interface of the mobile terminal, and an indication of this coupling of a headset with the mating port is generated at Block 306 (for example, for transmission to a processor and/or memory of the mobile terminal). At Block 308, data, such as an electronic mail (email) message, is provided to the mobile terminal, either from a memory of the mobile terminal or via a communications link (e.g., an antenna and communications unit) of the mobile terminal. In some cases, at Block 310, the email message is displayed visually via a display device of the mobile terminal, although this step may not be present in some embodiments.

At Block 312, a determination may be made as to whether the indication of headset insertion is present (for example, as determined by the processor, which might access the memory to locate the indicator). If the indication of headset insertion is present, the email might be additionally outputted in audio form at Block 314, perhaps via the headset. For example, a voice synthesis program may be incorporated into the mobile terminal, possibly stored in the memory and executed by the processor, such that text email messages can be represented and outputted in audio form. In other embodiments, a mutually exclusive choice might be made between an audio output and a visual output for data, depending on whether the indication of headset insertion was present. At Block 316, the process is concluded, at which point the process might repeat itself for subsequently received data.

In some exemplary methods for using a mobile terminal as described above, a user may enter settings, perhaps via a user input device of the mobile terminal, to adjust operation of the mobile terminal. For example, at one point in a day, a user may attend a large seminar, during which time the user desires to monitor his/her incoming emails while still focusing as much as possible on the seminar. With this objective in mind, the user may adjust settings of the mobile terminal to cause an abbreviated audio representation of received emails to be outputted when a headset is coupled to the mobile terminal, with full visual representations being outputted via a display device of the mobile terminal. For example, a voice synthesizer may be used to output in audio form, via the headset, the subject line of each email and the respective sender's name. In this way, the user will be only minimally distracted by each email, and will have the option to consult the display device, when necessary, to fully review a message (e.g., dealing with a critical matter). Later, this same user may be preparing to drive from the seminar to another location. At that time, the user might adjust the settings of the mobile terminal to cause a full audio representation of received emails to be outputted when the mobile terminal and headset are coupled. In this way, the user will be able to fully monitor his/her received emails without having to divert his/her eyes from the road while driving.

The above method has been described with respect to the output of data received in the form of email. However, any form of data may be utilized in conjunction with the above described embodiments. For example, calendaring data may be utilized, whereby an audio representation of various appointments may be outputted. Specifically, settings of a mobile terminal may be adjusted to cause an audio representation of an appointment to be outputted in association with an alarm signal indicative of the fact that the time for an appointment is approaching.

As described above and as will be appreciated by one skilled in the art, embodiments of the present invention may be configured as a system, an apparatus, or a method. Accordingly, embodiments of the present invention may be comprised of various means including entirely of hardware, entirely of software, or any combination of hardware and software. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mobile terminal comprising:
an audio device configured to selectively output an audio representation of at least some data;
a display device configured to output a visual representation of the at least some data;
an interface for detecting and generating an indication of an external event; and
a processor configured to receive the indication of the external event and to cause said audio device to output the at least some data in response to the indication of the external event.

2. A mobile terminal according to claim 1, wherein said display device is configured to selectively output a visual representation of the at least some data, and said processor is configured to select between said audio device and said display device for outputting a representation of the at least some data based on the indication of an external event.

3. A mobile terminal according to claim 1, wherein the at least some data includes alarm data and data associated with the alarm data.

4. A mobile terminal according to claim 1, wherein the at least some data is a subset of all data received by said processor, the subset being selected based on user defined criteria.

5. A mobile terminal according to claim 1, wherein said audio device includes a coupling portion for coupling to a headset.

6. A mobile terminal according to claim 5, wherein said interface is integrated with said coupling portion, said interface providing the indication when a headset is coupled to the coupling portion.

7. A mobile terminal according to claim 1, further comprising a memory in communication with said processor and configured to store a setting, wherein said processor is configured to selectively cause said audio device to output the at least some data based on the setting.

8. A mobile terminal according to claim 7, further comprising a user input device in communication with said processor, and wherein the setting is received via said user input device.

9. A method for generating an output, said method comprising:
outputting a visual representation of data;
providing an indication of an external event; and
based on the indication of the external event, outputting an audio representation of the data.

10. A method according to claim 9, wherein outputting a visual representation of the data includes selectively outputting a visual representation of the data, and further comprising selecting between an audio and visual representation for outputting the data.

11. A method according to claim 9, wherein detecting an external event includes detecting a coupling of a headset and a mobile terminal.

12. A method according to claim 9, wherein outputting an audio representation of data includes outputting alarm data and data associated with the alarm data.

13. A method according to claim 9, further comprising storing a setting, and wherein providing an indication of the external event includes selectively providing an indication of the external event based on the setting.

14. A method according to claim 13, further comprising receiving the setting from a user input device.

15. A computer program product comprising a computer-readable storage medium having computer-readable program code portions stored therein, the computer-readable program code portions comprising:
a first executable code portion configured to provide data;
a second executable code portion configured to output a visual representation of at least some of the data;
a third executable code portion configured to detect an external event;
a fourth executable code portion configured to provide an indication of the external event; and
a fifth executable code portion configured to output an audio representation of at least some of the data based on the indication of the external event.

16. A computer program product according to claim 15, wherein said third executable code portion includes an executable code portion configured to detect coupling of a headset and a data device.

17. A computer program product according to claim 15, wherein said fifth executable code portion includes an executable code portion configured to output alarm data and data associated with the alarm data.

18. A computer program product according to claim 15, further comprising a sixth executable code portion configured to store a setting, and wherein said fourth executable code portion includes an executable code portion configured to selectively provide an indication of the external event based on the setting.

19. A computer program product according to claim 18, further comprising a seventh executable code portion configured to receive the setting from a user input device.

20. An apparatus comprising:
means for selectively outputting an audio representation of at least some data;
means for outputting a visual representation of the at least some data;
means for detecting and generating an indication of an external event; and
means for receiving the indication of the external event and causing said audio output means to output the at least some data in response to the indication of the external event.
